(19) United States
(12) Patent Application Publication
(10) Pub. No.: US 2008/0266837 A1
(43) Pub. Date: Oct. 30, 2008

(54) Flashlight

(76) Inventors: Brian Mehler, Long Beach, CA (US); Andrew Palmer, Palm Desert, CA (US)

Correspondence Address: GRAY LAW FIRM;Suite 233, 4401 N. Atlantic Ave., Long Beach, CA, 90807, US

(21) Appl. No.: 11/796,183

(22) Filed: Apr. 26, 2007

(51) Int. Cl. F21V 21/08

(52) U.S. Cl. 362/103

(57) ABSTRACT

The present invention is an improved flashlight. In particular, the present invention is directed to an LED flashlight tag inserted into a perimeter buffer that can also hold an identification tag. The flashlight has a two-sided flashlight tag that contains a power supply, two light sources and a power switch. The flashlight tag is inserted into a perimeter buffer that exposes an exterior side of the flashlight tag and has sufficient space to contain an identification tag adjacent to an interior side of the flashlight tag.

### TECHNICAL FIELD

The present invention is an improved flashlight. In particular, the present invention is directed to an LED flashlight tag inserted into a perimeter buffer that can also hold an identification tag.

### BACKGROUND ART

Generally, a number of thin LED flashlights exist in the prior art such as U.S. Pat. No. 4,408,261 to Polakoff and Patent Application Publication US 2006/0176679 to Lee. However, the LED flashlights can be easily lost or misplaced unless they are worn on a user's person at all times and preferably integrated with another object that is worn on the user's person at all times. Therefore, a thin LED flashlight integrated with a commonly worn object worn on the user's person at all times is desired.

### SUMMARY OF THE INVENTION

The present invention is an improved flashlight. In particular, the present invention is directed to an LED flashlight tag inserted into a perimeter buffer that can also hold an identification tag. The flashlight has a two-sided flashlight tag that contains a power supply, two light sources and a power switch. The flashlight tag is inserted into a perimeter buffer that exposes an exterior side of the flashlight tag and has sufficient space to contain an identification tag adjacent to an interior side of the flashlight tag.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a perspective view of a preferred embodiment of the invention;

FIG. 2 is an exploded view of a preferred embodiment of the invention;

FIG. 3 is an end view of a preferred embodiment of the invention;

FIG. 4 is an internal view of a preferred embodiment of a flashlight tag;

FIG. 5a is an exploded perspective view of another preferred embodiment of the invention;

FIG. 5b is a cross-sectional side view of the preferred embodiment in FIG. 5a;

FIG. 6 is a perspective view of another preferred embodiment of the invention; and,

FIGS. 7a, 7b and 7c are top views of preferred embodiments of a power switch with touch indicators for the flashlight tag.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved flashlight.

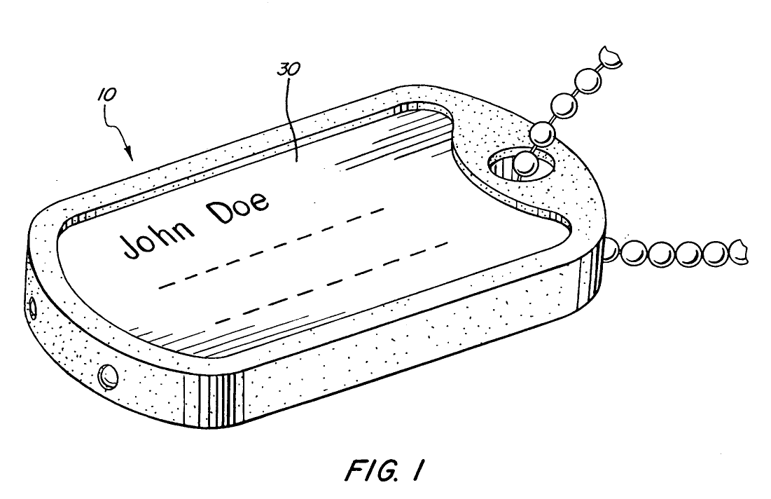

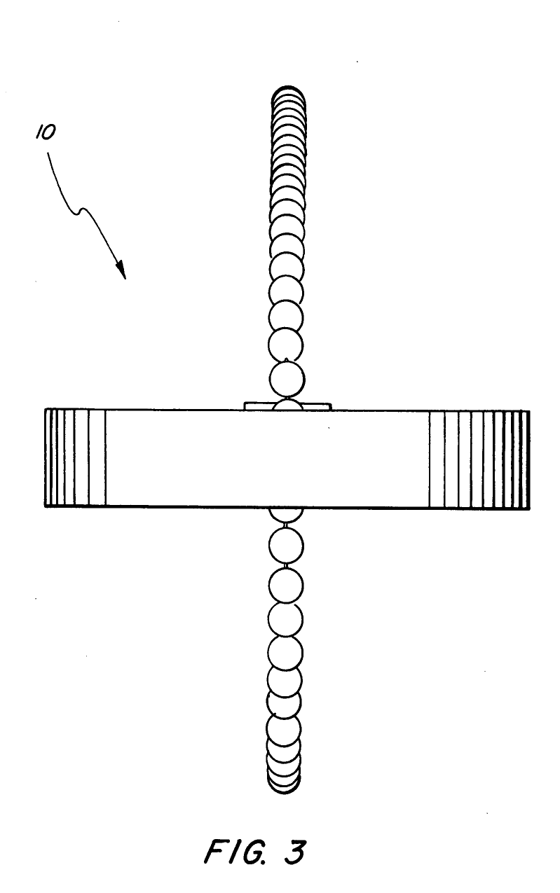

Referring now to FIG. 1, a perspective of a preferred embodiment of the invention 10 is shown. The preferred embodiment comprises a perimeter buffer 20 or “silencer” that contains an identification tag 30, e.g. a United States military identification tag or “dog tag,” and a flashlight tag 40. The tags 30 and 40 and the buffer 20 are strung on a neck chain 100. FIG. 3 shows an end view of the preferred embodiment of FIG. 1. The perimeter buffer 20 is preferably made from silicone and fits firmly around the flashlight tag 40 and identification tag 30 to provide additional waterproofing and/or water resistance. The perimeter buffer 20 can also be made of, inter alia, rubber or polyvinyl chloride (PVC).

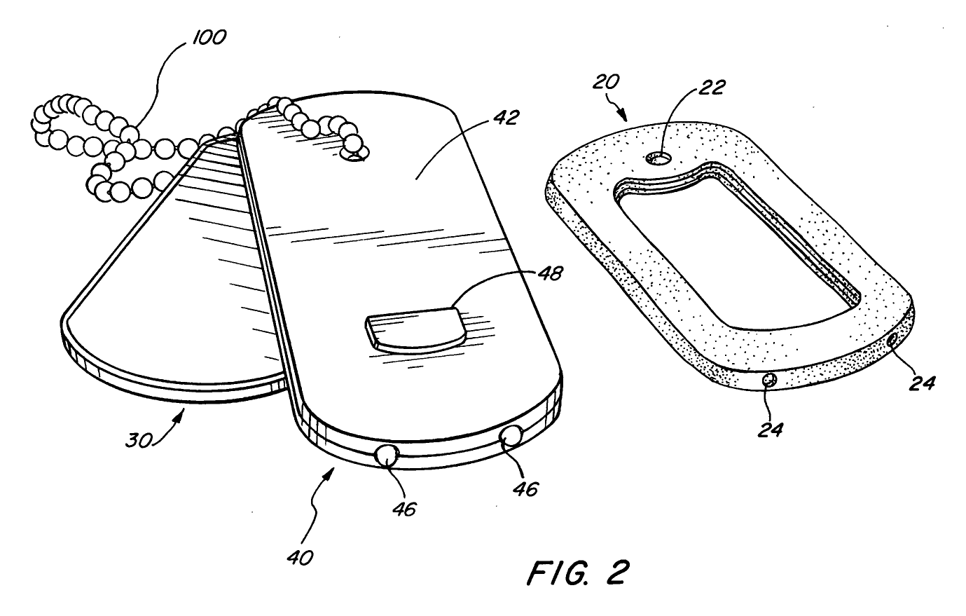

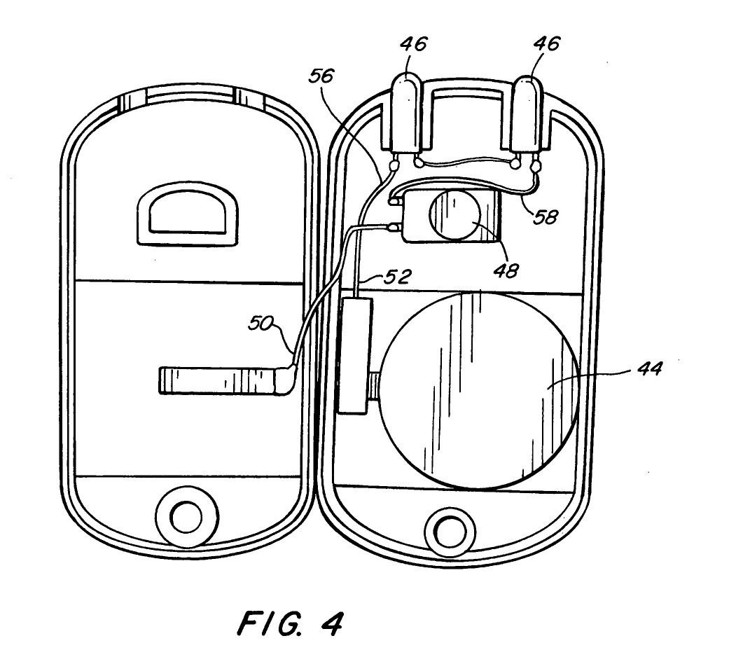

FIG. 2 shows an explode view of the preferred embodiment of FIG. 1. The flashlight tag 40 has an interior side and an exterior side 42. The flashlight tag 40 contains a power supply 44 (see FIG. 4), preferably two light emitting diode (LED) light sources 46 and a power switch 48 on the exterior side 42. The flashlight tag 40 is inserted into the perimeter buffer 20. Preferably, the exterior side 42 of the flashlight tag 40, in particular the power switch 48, is exposed. The perimeter buffer 20 preferably has a hole 22 to string the neck chain 100, and light holes 24 aligned with the light sources 46 on the flashlight tag 40. The perimeter buffer 20 also has sufficient space to contain an identification tag 30 covering and/or adjacent to the interior side of the flashlight tag 20.

Referring now to FIG. 4, an interior view of a preferred embodiment of the flashing light tag 40 in FIGS. 1 and 2 is shown. The flashlight tag 40 preferably has two 3-volt lithium batteries (e.g., Maxell or New Leader CR2016) as the power source 44, six volts total. Alternately, the power source 44 can be, inter alia, 6 volts or 3 volts with 1 battery, 2 batteries or more depending on various factors such as tag thickness, desired battery life and LED color, e.g. red LEDs can run on 3V only. The power source 44 is electrically connected to the power switch 48 by leads 50 and 52. In turn, the power switch 48 is connected to the LEDs 46 by leads 56 and 58. The power source 44 is preferably held in the flashlight tag 40 by a power source cover 45.

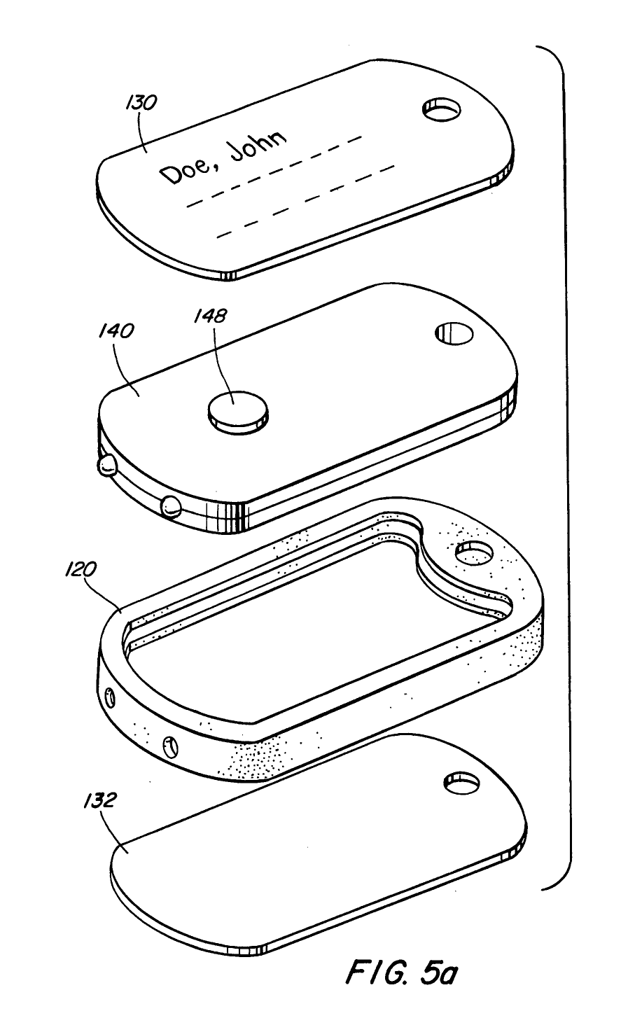

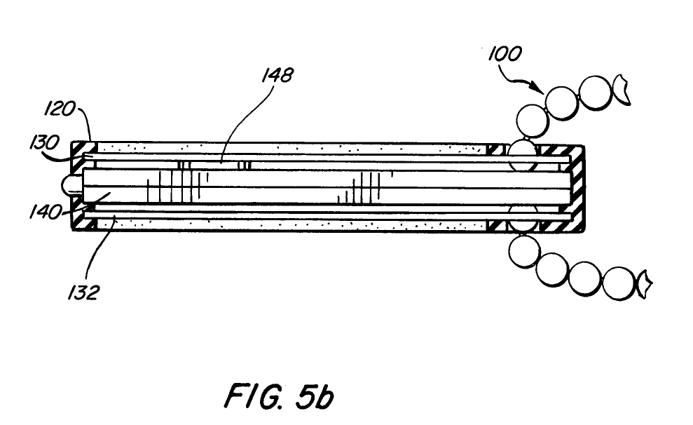

Referring now to FIG. 5a, an exploded perspective view of another preferred embodiment is shown. Often identification tags come in sets such as pairs. The preferred embodiment of FIG. 5 allows the user to insert identification tags 130 and 132 into a perimeter buffer 120 having an interior space sufficiently large enough to have a first exterior position, a middle position, and a second exterior position. Preferably, a first tag 130 is inserted into the first exterior position of the perimeter buffer 120. A flashlight tag 140 is then inserted into the middle position aligned with light holes 124 on the perimeter buffer 120. The flashlight tag 140 (as in FIG. 4) contains a power supply, at least one, preferably two LED light sources, and at least one depressible power switch 148. A second tag 132 is then inserted into the second exterior position opposite the first tag 130 and surrounding the flashlight tag 140. A user can light the flashlight in FIG. 5 by squeezing the tags 130 and 132 and depressing the power switch 148.

FIG. 5b is a side cross-sectional view of the preferred embodiment in FIG. 5a. As discussed above, the flashlight tag 140 is preferably sandwiched between the tags 130 and 132. The tags 130, 132 and 140 are strung on the neck chain 100. This allows both identification tags 130 and 132 to be read while inside the perimeter buffer 120.

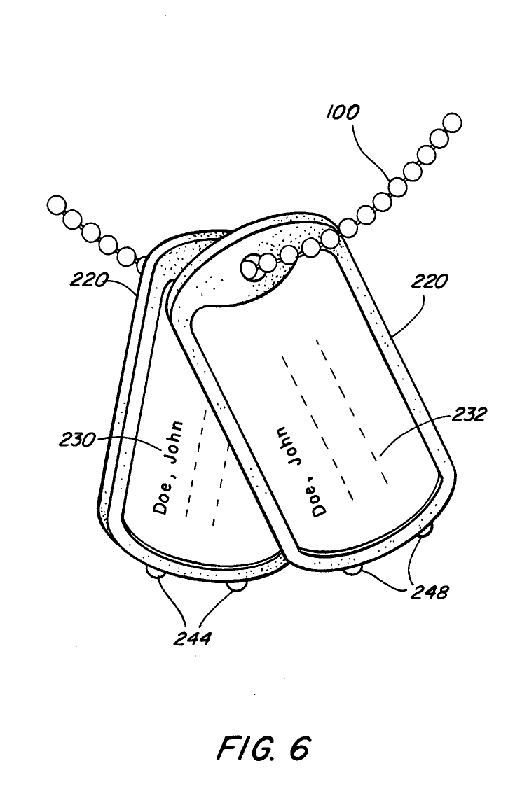

Referring now to FIG. 6, a perspective view of yet another preferred embodiment is shown. In this embodiment, a set of identification tags 230 and 232 are shown inside perimeter buffers 220. Each tag sits above a flashlight tag similar to those described above. Preferably, each flashlight tag has a different color or wavelength light source emitted by LEDs 244, 248. For example, military or police personnel find it useful to have both a white or blue light source and a red light source available. Red light is generally considered less debilitating to night vision when used for illumination. Other possible light sources include blue, green, infrared and ultraviolet light. Alternately, one of the light sources 244, 248 could be a laser. When using white LEDs, the light sources are preferably Nichia White LEDs, Model Number NSPW300CS.

Alternately, a control circuit can be attached to the light source in the above embodiments to generate a strobe/flash effect with variable speeds. For example, the light source could generate, inter alia, an “SOS” emergency flashing signal. The control circuit could also turn the light source on and off rapidly to conserve battery life. The control circuit would preferably comprise an integrated circuit (IC) chip.

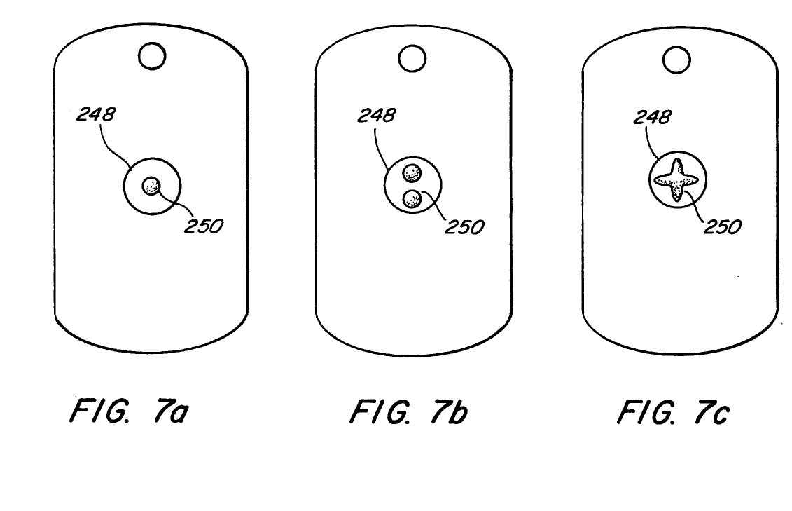

Referring now to FIGS. 7a, 7b and 7c, possible bottom views of the preferred embodiments of the flashlight tags in FIG. 6 are shown. In particular, the power switches 248 have touch indicators 250, e.g. distinctly shaped nubs on the power switches. By having touch indicators 250 on the power switch 248, users will be able to distinguish between the different color or wavelength light sources available for each flashlight tag without turning the flashlight tag on. For example, a single nub could indicate white light while two nubs could indicate red light. Another example could be a cross nub indicating infrared light or some other color or wavelength of light. Preferably, the touch indicators are easy to distinguish from one another by sense of touch so they can be “read” in low light situations.

Preferably, each of the embodiments described herein are water-resistant or waterproof. For example, the perimeter buffer can act as a gasket or seal to prevent water from damaging the flashlight tag held within. This would allow a user to keep the flashlight on his or her person at all times, such as in the shower, without concern that the flashlight would be damaged by water intrusion.

Thus, an improved flashlight is described above that is integrated with a device worn on the user's person at all times, namely an identification tag. In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A flashlight comprising:
a flashlight tag with an interior side and an exterior side; said flashlight tag containing a power supply, at least one light source and a power switch on the exterior side;
said flashlight tag inserted into a perimeter buffer that exposes the exterior side of the flashlight tag and has sufficient space to contain a tag adjacent to the interior side of the flashlight tag.

2. The flashlight of claim 1 where the flashlight tag is shaped like a United States military identification tag.

3. The flashlight of claim 1 where the perimeter buffer is made of silicone rubber.

4. The flashlight of claim 1 where the flashlight further comprises an identification tag inserted into the sufficient space of the perimeter buffer.

5. A flashlight comprising:
a perimeter buffer containing an interior space having a first exterior position, a middle position, and a second exterior position;
a first tag inserted into the first exterior position;
a flashlight tag inserted into the middle position; said flashlight tag containing a power supply, at least one light source and at least one depressible power switch;
a second tag inserted into the second exterior position.

6. The flashlight of claim 5 where the flashlight can alternately emit different colors or wavelengths of light.

7. The flashlight of claim 5 where the perimeter buffer comprises silicone.

8. The flashlight of claim 5 where the flashlight is water resistant.

9. The flashlight of claim 5 where the first tag, flashlight tag and second tag are each shaped like a United States military identification tag.

10. An identification tag flashlight set comprising:
a first perimeter buffer containing an interior space having a first position and a second position;
a first identification tag inserted into the first position;
a first flashlight tag inserted into the second position; said first flashlight tag containing a power supply, a first light source and a power switch;
a second perimeter buffer containing an interior space having a first position and a second position;
a second identification tag inserted into the first position;
a second flashlight tag inserted into the second position; said second flashlight tag containing a power supply, a second light source and a power switch.

11. The identification tag flashlight set of claim 10 where the set is strung on a neck chain.

12. The identification tag flashlight set of claim 10 where the first flashlight tag emits at least white light.

13. The identification tag flashlight set of claim 10 where the first flashlight tag emits at least red light.

14. The identification tag flashlight set of claim 10 where the first flashlight tag emits at least green light.

15. The identification tag flashlight set of claim 10 where the first flashlight tag emits at least infrared light.

16. The identification tag flashlight set of claim 10 where the first flashlight tag emits at least ultraviolet light.

17. The identification tag flashlight set of claim 10 where the first flashlight tag emits a laser light.

18. The identification tag flashlight set of claim 10 where the first and second flashlight tags emit lights of different colors or wavelengths.

19. The identification tag flashlight set of claim 10 where the first flashlight tag emits light with a flashing pattern or a strobe effect.

20. The identification tag flashlight set of claim 10 where the first flashlight tag power switch and the second flashlight power switch have indicator markings that indicate the types of light emitted from the first and second light sources.
